(19) United States
(12) Patent Application Publication
(10) Pub. No.: US 2014/0279020 A1
(43) Pub. Date: Sep. 18, 2014

(54) SYSTEMS AND METHODS FOR SEARCHING VEHICLE LISTINGS

(71) Applicants: Annie DUGUID, Atlanta, GA (US); Joe GEORGE, Atlanta, GA (US); Amy MILLS, Atlanta, GA (US); Krista MARLATT, Atlanta, GA (US); Bonnie HENSLER, Atlanta, GA (US)

(72) Inventors: Annie DUGUID, Atlanta, GA (US); Joe GEORGE, Atlanta, GA (US); Amy MILLS, Atlanta, GA (US); Krista MARLATT, Atlanta, GA (US); Bonnie HENSLER, Atlanta, GA (US)

(21) Appl. No.: 13/840,475

(22) Filed: Mar. 15, 2013

(51) Int. Cl. G06Q 30/02

(52) U.S. Cl. CPC G06Q 30/0265
USPC 705/14.62

(57) ABSTRACT

The present disclosure relates to computer-implemented systems and methods for searching vehicle listings. An example method may include receiving one or more financial parameters. The method may also include generating one or more proposed transactions that may be defined, at least in part, by the one or more financial parameters. Additionally, the method may include determining, based at least in part on the one or more proposed transactions, for one or more advertised offers associated with one or more vehicles. The method may also include transmitting at least one advertised offer of the one or more advertised offers.

### TECHNICAL FIELD

The present disclosure generally relates to web searches, and in particular, to searching vehicle listings.

### BACKGROUND

With the advent of e-commerce, online businesses conduct vast amounts of transactions every day. As such, users are able to perform extensive online research using robust search engines before purchasing a product. With the increase in online research, additional opportunities for website advertisements arise. Both online businesses and those advertisers that advertise on the businesses' websites may be interested in determining, which web content drives user activity on their websites.

### BRIEF DESCRIPTION OF THE DRAWINGS

Reference will now be made to the accompanying figures and diagrams, which are not necessarily drawn to scale, and wherein:

FIG. 1 shows a system for searching vehicle listings according to one or more example embodiments.

FIG. 2 shows a data flow diagram for searching vehicle listings according to one or more example embodiments.

FIG. 3A shows a block diagram of financial parameters, according to one or more example embodiments.

FIG. 3B shows a data flow diagram for determining credit data according to one or more example embodiments.

FIG. 4A shows a user interface for searching vehicle listings, according to one or more example embodiments.

FIG. 4B shows a user interface for searching vehicle listings, according to one or more example embodiments.

FIG. 4C shows a user interface for searching vehicle listings, according to one or more example embodiments.

FIG. 4D shows a user interface for searching vehicle listings, according to one or more example embodiments.

FIG. 5 shows a flow diagram of a method for searching vehicle listings, according to one or more example embodiments.

FIG. 6 shows a block diagram of a dealer device, according to one or more example embodiments.

### DETAILED DESCRIPTION

In the following description, numerous specific details are set forth. However, it should be understood that embodiments of the present disclosure may be practiced without these specific details. In other instances, well-known methods, structures, and techniques have not been shown in detail in order not to obscure an understanding of this description. References to “one embodiment,” “an embodiment,” “example embodiment,” “various embodiments,” and so forth indicate that the embodiment(s) of the present disclosure so described may include a particular feature, structure, or characteristic, but not every embodiment necessarily includes the particular feature, structure, or characteristic. Furthermore, the repeated use of the phrase “in one embodiment” does not necessarily refer to the same embodiment, although it may.

As used herein, unless otherwise specified, the use of the ordinal adjectives “first,” “second,” “third,” etc., to describe a common object merely indicates that different instances of like objects are being referred to and are not intended to imply that the objects so described must be in a given sequence, either temporally, spatially, in ranking, or in any other manner.

As used herein, unless otherwise specified, the term “user device” refers, in general, to an electronic communication device, both wired and wireless, and more particularly to one or more of the following: a portable electronic device, a telephone (e.g., cellular phone, smartphone), a computer (e.g., laptop computer, tablet computer, desktop computer, wearable computer), a portable media player, a personal digital assistant (PDA), a kiosk computer for public use, or any other electronic device having a networked capability.

As used herein, unless otherwise specified, the term “server” may refer to any computing device having a networked connectivity and configured to provide one or more dedicated services to clients, such as a mobile device. The services may include storage of data or any kind of data processing. One example of a central server may include a web server hosting one or more web pages. Some examples of web pages may include social networking web pages. Another example of a server may be a cloud server that hosts web services for one or more computer devices.

As used herein, unless otherwise specified, the term “web page” may correspond to one or more web pages as part of one or more websites.

Embodiments of the present disclosure may generally relate to facilitating searches for vehicle listings based at least in part on financial parameters, which may be input by a user. Broadly, a user may be able to perform a search for vehicle listings using financial data as search criteria rather than specifying a particular vehicle and/or aspects of a vehicle (e.g., make, model, year, etc.) as search criteria.

For example, some embodiments may include a user device, a server, and a dealer device in communication with each other over a network. The user device may present the user with a user interface that prompts the user to enter certain financial parameters (e.g., target price, down payment amount, financing terms, trade-in amounts, etc.). Depending on certain circumstances, such financial parameters may be provided by the user, a third party service provider, a dealer, and/or a combination thereof. Additionally, these financial parameters may be received by a transaction application that may be executed by the user device, the server, or any combination thereof. Similarly, the financial parameters may be stored on any combination of the user device and the server.

Based at least in part on the financial parameters, the transaction application may generate one or more proposed transactions. The one or more proposed transactions may include the financial parameters, and in some cases, may also be associated with respective target monthly payment amounts calculated based at least in part on the financial parameters. Thus, in some embodiments, the one or more proposed transactions may consolidate the financial parameters, which a user may be considering with respect to purchasing a vehicle, into one or more target monthly payments.

Once the transaction application has generated the one or more proposed transactions, the transaction application may perform one or more searches based at least in part on the one or more proposed transactions. In some embodiments, the searches may relate to searches for vehicle listings. To this end, the vehicles listings returned from the search may be associated with one or more advertised offers for certain vehicles. The advertised offers may be associated with certain advertised financial information that may fall within a predetermined range of the financial parameters associated with the one or more proposed transactions. Thus, the present disclosure may describe systems and methods that enable a user to search for vehicle listings based at least in part on using one or more financial parameters as search criteria.

In other embodiments, in addition to searching for vehicle listings, the transaction application may facilitate searches, based on one or more proposed transactions, for dealers and/or dealerships that may wish to communicate with the user regarding the proposed transactions. To facilitate communication between the dealer and user, dealer devices associated with dealers may include dealer applications. The dealer applications may provide an interface for dealers to receive and analyze the proposed transactions associated with user searches.

For example, the dealer application may be configured to monitor and/or receive proposed transactions associated with a user's search for dealers and/or vehicle listings. As such, the dealer application may be configured to analyze the proposed transactions, such as financial parameters and/or target monthly payments associated with the proposed transactions, in relation to the dealer's inventory and/or other factors. In response to the proposed transactions, the dealer application may calculate or determine potential counter-offers associated with certain vehicles in inventory. Such counter-offers may be determined based at least in part on certain adjustable factors that the dealer may designate. For instance, the dealer may wish to set a certain profit margin and/or may wish to protect a particular profit margin with respect to the vehicle price, trade-in value of another vehicle, or other financial criteria.

In some embodiments, the dealer application may also be configured to identify one or more inventory-specific opportunities based on the proposed transactions. For example, certain vehicles may have remained in inventory for a relatively long period. Based on the proposed transactions, the dealer application may identify such vehicles for which the dealer may consider creating a potential counter-offer.

Thus, according to one or more embodiments of the disclosure, a method is provided. The method may include receiving, by a computer that includes one or more processors, one or more financial parameters associated. The method may also include generating, by the computer, one or more proposed transactions, the one or more proposed transactions defined at least in part by the one or more financial parameters. Furthermore, the method may include determining, by the computer based at least in part on the one or more proposed transactions, for one or more advertised offers associated with one or more vehicles. In addition, the method may include determining, by the computer, at least one advertised offer of the one or more advertised offers, the at least one advertised offer corresponding to at least one proposed transaction of the one or more proposed transactions.

According to one or more embodiments of the disclosure, a system is provided. The system may have at least one processor and at least one memory storing computer-readable instructions. When the instructions are executed by the at least one processor, the instructions may cause the at least one processor to receive one or more financial parameters. The instructions may further cause the at least one processor to generate one or more proposed transactions, based at least in part on the one or more financial parameters. Moreover, the instructions may cause the at least one processor to determine, based at least in part on the one or more proposed transactions, one or more advertisements for respective vehicles, the one or more advertisements associated with one or more advertised financial parameters To this end, the one or more advertised financial parameter may be within a predetermined range of at least one of the one or more financial parameters.

According to one or more embodiments of the disclosure, a non-transitory computer-readable medium is provided. The non-transitory computer-readable medium may have embodied thereon instructions executable by one or more processors. The instructions may cause the one or more processors to receive one or more financial parameters. Furthermore, the instructions may cause the one or more processors to generate one or more proposed transactions. As such, the one or more proposed transactions may be defined by the one or more financial parameters. Additionally, the instructions may cause the one or more processors to determine, using the one or more proposed transactions, one or more advertisements associated with respective vehicles. The instructions may also cause the one or more processors to transmit the one or more advertisements.

The above principles, and perhaps others, are now illustrated with reference to FIG. 1, which depicts a system 100 for searching vehicle listings. The system 100 may include one or more user devices 105. The user device 105 may include one or more processors 110 in communication with a memory 120 and a display 145 for displaying various information, such as a user interface, for example. The memory 120 may store a variety of user applications and other data having instructions to be executed by the processor(s) 110. For example, the memory 120 may store a transaction application 125, which may include a transaction generation module 130a and financial module 135. Furthermore, the memory 120 may also store a web browser 140.

According to some embodiments, the system 100 may also include one or more service provider servers 155 in communication with the user device(s) 105 through one or more networks 150. The service provider server(s) 155 may include processor(s) 160 in communication with memory 165. The memory may store an operating system 170 and a search engine 175, which may include a dealer search module 180 and a vehicle search module 185. In some embodiments, the service provider server(s) 155 may also include a transaction generation module 130b. Additionally, the service provider server(s) 155 may include Input/Output (I/O) devices 190 and storage 195. The I/O devices 190 may include various peripheral and/or internal components including, but not limited to, keyboards, mice, displays, network interface cards, disk controllers, web cams, and/or other devices. The storage 195 may include any kind of storage devices, such as hard disk drives, solid-state drives, flash drives, tape drives, compact disc drives, DVD drives, Blu-Ray drives, network attached storage, remote storage locations, and/or the like.

Additionally, the system 100 may also include one or more dealer devices 106 and third-party service provider devices 107 in communication with the network 150. Such devices may be discussed in more detail with respect to the discussion of subsequent figures. In particular, the dealer devices 106 may be discussed in more detail with reference to FIG. 6.

The discussion now begins with a broad description of embodiments that may enable users to perform searches for vehicle listings in view of the components illustrated in FIG. 1. Thereafter, such components, and interactions between such components, may be described in more detail with respect to certain embodiments of the present disclosure.

As stated above, the memory 120 of the user device(s) 105 may store one or more transaction applications 125. In general, the transaction application(s) 125 may facilitate searches for vehicle listings and/or dealers. To this end, the transaction application 125 may be configured to receive, from a user of the user device(s) 105, input of one or more financial parameters associated with a potential, unspecified vehicle purchase. The financial parameters may be received and/or stored on the user device(s) 105 by the transaction application 125 and/or financial module 135. As such, the transaction application 125 may construct/generate one or more proposed transactions based at least in part on the financial parameters included in the financial module 135. The one or more proposed transactions may be sent to the search engine 175 on the service provider server(s) 155. As such, the search engine 175 may perform a search, based at least in part on the one or more proposed transactions, for actual vehicle listings and/or for dealers. To this end, vehicle listings returned by the search may be associated with advertised offers that match or approximate one or more aspects of the proposed transactions. Moreover, the search may also return dealers who may be interested in negotiating the sale of one or more vehicles based on the one or more proposed transactions. In some embodiments, one or more dealer device(s) 106 may also be in communication with the user device(s) 105 and service provider server(s) 155 through the network 150. Such dealer devices are described in more detail with reference to FIG. 6, which is described below.

Referring back to the transaction application 125, the transaction generation module 130a of the transaction application 125 may be configured to generate one or more proposed transactions based on financial parameters input by the user. For example, the transaction application 125 may request or prompt the user for input of the financial parameters, such as through a user interface. To this end, the user interface may include a form (e.g., a web form) in which the user may input such information. The financial parameters may include information such as a target price for a potential vehicle purchase, desired monthly payments, a down payment, financing terms (e.g., loan duration, interest terms, etc.), trade-in vehicles, credit scores, and/or any other financial information related to purchasing a vehicle. As previously stated, such financial parameters may be stored on the user device(s) 105 but may also be stored elsewhere, such as on the service provider server(s) 155 and/or any other storage location. To this end, the transaction generation module 130a may generate one or more proposed transactions based at least in part on the financial parameters received by the financial module 135.

Thus, in some embodiments, the proposed transactions may generally represent financial data around which a user may be willing to structure a deal to purchase a vehicle. For example, the user may be willing to put a down payment of $10,000 toward a purchase of a $30,000 vehicle. Additionally, the user may be willing to finance the remaining portion of the purchase according to financing terms of a 3% annual percentage rate (APR) for 48 months. To this end, all such financial information, when input into and received by the transaction application 125, may be used to generate a proposed transaction. In some embodiments, the proposed transactions may also be associated with respective target monthly payments. In situations where the target monthly payments are not initially supplied by the user, target monthly payments may be calculated by the financial module 135 and may be derived, at least in part, from the financial parameters input by the user. With reference to the above example, the financial module 135 may calculate a target monthly payment of $443 for the proposed transaction. In other examples, the user may supply a target monthly payment that he/she can afford as well as other financial parameters (e.g., down payment, trade-in, loan duration, interest rate, etc.) to the transaction generation module 130a and/or the financial module 135. Accordingly, the financial module may calculate, from the financial parameters, a target price up to which the user may be able to afford in purchasing a new vehicle. It should be understood that the above numbers are merely illustrative of financial parameters and are not necessarily accurate.

According to one or more embodiments, the user may also be provided the option of storing proposed transactions generated by the transaction generation module 130a. The proposed transactions may be stored on the user device(s) 105 and/or the service provider server(s) 155. Thus, the user may also be able to retrieve previously generated proposed transactions to perform a variety functions. For example, the user may perform a search for one more listings based on the previously generated proposed transactions. As another example, the user may retrieve the previously generated proposed transactions to compare with newly generated proposed transactions. In certain embodiments, in order to facilitate generating, storing, retrieving, and viewing proposed transactions, a user interface may be provided. Such a user interface is described in more detail with reference to FIGS. 4A-D below.

According to certain embodiments, when a user decides to perform a search based on the one or more proposed transactions, the transaction application 125 may transmit the one or more proposed transactions to the search engine 175 in the service provider server(s) 155. Depending on the type of search that the user may desire, the search engine 175 may utilize the dealer search module 180 and/or the vehicle search module 185. If the user desires to search for vehicle listings, the searching engine 175 may use the vehicle search module 185 to perform a search, based at least in part on the one or more proposed transactions, for vehicle listings. Such search options may be provided to the user in a user interface, which again, is described in more detail with reference to FIG. 4 below.

For example, in some embodiments, the vehicle listings returned by the search engine 175 may be advertisements and/or may be associated with advertised offers for respective vehicles. As previously stated, such advertised offers may be returned in response to a search using the proposed transactions, which may be generated from the financial parameters input by the user. As such, the advertised offers may be associated with one or more advertised financial parameters that are within a predetermined range of at least one of the financial parameters. For instance, the one or more proposed transactions generated by the transaction generation module 130a may be associated with respective target monthly payments. For example, a proposed transaction of a user may be associated with a target monthly payment of $400/month, which may indicate that the user may wish to purchase a vehicle under certain financial parameters that would lead to a cost of $400/month. Based on this proposed transaction, the user may perform a search for vehicle listings having advertised offers associated with advertised monthly payments within a predetermined range of the target monthly payment (e.g., $400/month). For example, the user may specify that search results return vehicle listings associated with advertised monthly payments within $25/month of the target monthly payment. In another example, the user may specify that the search results return vehicle listings associated with advertised monthly payments not more than a certain amount, e.g., $25, more than the $400/month target. Alternatively, the user may wish to see vehicle listing associated with monthly payments less than $400/month.

In some implementations, the search engine 175 may be in communication with the dealer devices 106 and/or the third-party service provider devices 107. Third-party service providers devices 107 may include devices associated with banks, original equipment manufacturers, one or more dealers, auction sites, and/or the like. As a result, one or more of the advertised financial parameters may be provided by the dealer devices 106 and/or the third-party service provider servers 107. For instance, a user's credit data may be included as one of the financial parameters used to generate a proposed transaction. When a search is performed based on the proposed transaction, the search engine 175 may provide the user's credit data to the dealer devices 106 and/or the third-party service provider servers 107. Based at least in part on the user's credit data, certain advertised financial parameters including, but not limited to loan/lease terms and duration, cash incentives, rebates, trade-in incentives, and/or other advertised financial parameters (e.g., offered by dealers, third-party service providers, financial institutions, or any other entity) may be provided to the search engine 175. The search engine 175 may then be configured to return these advertised financial parameters to the user (e.g., as part of a vehicle listing search result).

Thus, in addition to a range of target monthly payments, the use may also perform searches according to other financial parameters. For example, the search may be performed using any criteria (e.g., minimums, maximums, quantities, etc.) associated with target prices, financing rate, financing length, trade-in amount etc. Thus, interaction between the transaction generation module 130a and the vehicle search module 185 may facilitate searches for vehicle listings based at least in part on one or more proposed transactions generated by the transaction generation module 130a. Furthermore, this search may be performed without the user identifying a particular vehicle to search for. Moreover, the returned vehicle listings may represent actual inventory associated with one or more dealers or sellers. Thus, the vehicle listings may present the user with an opportunity to negotiate on a specific vehicle actually in inventory. In other embodiments, the only listings returned may represent actual inventory associated with one or more dealers or sellers. In this way, the user's search may always be grounded in vehicles that the user can actually acquire.

According to other embodiments, in addition to vehicle listing searches, a dealer search may also be performed. To this end, the dealer search module 180 in the search engine 175 may be used to search, based at least in part on the one or more proposed transaction, for any dealers that may desire to communicate with the user regarding a potential vehicle for sale. For instance, based on the proposed transactions, the dealer search module 180 may return contact information associated with one or more dealers. In other embodiments, the dealer search module 180 may provide the one or more dealers with the user contact information, or it may only permit the dealers to communicate through the platform, which may preserve consumer anonymity until the consumer is ready to directly contact the dealer. In certain embodiments, the dealer search module 180 may be configured to transmit the proposed transactions to one or more dealers and/or dealer devices associated with the dealers. Based on the proposed transactions, the dealers may generate one or more counter-offers to transmit back to the user device(s) 105, either directly or through the service provider server(s) 155. Again, the description of such dealer devices may be provided in more detail with respect to the description of FIG. 6.

In some implementations, a geographical area may be specified for the dealer search (e.g., through a user interface, such as those described with respect to FIGS. 4A-D), thereby concentrating the search for dealers in that particular geographical area. For example, the user may manually input geographical data for the dealer search, or the geographical data may be determined for the user using Global Positioning Satellite data, Wi-Fi trilateration, cellular data (e.g., cellular towers), radio data, other wireless data, Internet Protocol addresses, and/or any other geo-location determination techniques. Such services may be provided by the transaction application 125, other applications included on the user device 105, the service provider servers 155, third-party service provider servers 107, and/or any other entity. Additionally, some embodiments may allow consumers to filter the returned dealer results by other parameters, such as, but not limited to, foreign language fluency, service departments, consumer reviews, pricing strategies, customer service ratings, and other amenities. In other embodiments, the dealer search module 180 may return a list of actual deals being promoted and/or advertised by one or more dealers. In other embodiments, the dealers may be able to monitor or may be otherwise notified of certain proposed transactions used in user searches. The dealer may then be able to propose counter-offers in response to proposed transactions, and these counteroffers may be presented to the respective users as search results by the dealer search module 180 in the search engine 175.

In some embodiments, searches executed by the dealer search module 180 and vehicle search module 185 may be performed with respect to one or more databases associated with the service provider server(s) 155. For example, the databases may be included within storage 195 or may be in communication with the service provider server(s) 155, dealer(s), and/or user device(s) 105 through the network 150. In particular, the service provider server(s) 155 may have access to one or more vehicle inventories 198 (e.g., databases that store information associated with vehicle inventories 198) associated with one or more dealers, advertised offers for sale and/or lease of vehicles, dealer websites, and other vehicle and/or dealer information. For example, the vehicle inventories 198 may store information associated with dealer contact information, geographical locations, services and amenities, specific vehicles-for-sale by a dealer, and/or vehicle specific information such as pricing information, financing information, make, model, trim, options, year, Vehicle Identification Numbers, and/or any other information associated with dealers and/or vehicles.

It should be appreciated that while certain embodiments have described the search engine 175 as being located in the service provider server(s) 155, the functionality of the search engine 175 and/or portions thereof (e.g., the dealer search module 180 and/or vehicle search module 185) may be performed or distributed to various components of the system 100. For example, in some embodiments, the search engine 175 may be included in the user device(s) 105 and/or a dealer device associated with one or more dealers.

Furthermore, while the description of certain embodiments above have portrayed the transaction application 125 as a dedicated application associated with the user device(s) 105, it should be understood that some and/or all of the functionality provided by the transaction application 125 may be performed by other components in the system 100 as well. For example, in some implementations, the service provider server(s) 155 may also include a transaction generation module 130b to facilitate generating one or proposed transactions based on financial parameters input by the user. In one or more of such implementations, the user device(s) 105 may employ the browser 140 to navigate to a web page served to the user device(s) 105 by the service provider server(s) 155. The web page may provide an interface (e.g., a web form) that enables the user to input, via the browser 140, one or more financial parameters, which may be stored on the user device(s) 105 and/or the service provider server(s) 155. Based at least in part on the financial parameters in the financial module 135, the transaction generation module 130b on the service provider server(s) 155 may generate one or more proposed transactions.

Thus, broadly, one or more embodiments described above may provide a system 100 to enable users to search for vehicle listings or dealers based on certain financial criteria rather than focusing on first identifying a particular vehicle, and then searching for vehicle listings that pertain to that particular vehicle. For example, the user may perform a vehicle search or a dealer search without first indicating the type, make, model, year, and/or any other specific detail that identifies a particular vehicle to search. However, it should be understood that the present disclosure also contemplates implementations where users may first identify a particular vehicle and base a search for vehicle listings based on the identified vehicle. To this end, the transaction application 125 may also generate proposed transactions based at least in part on the identified vehicle. Alternatively, the transaction application 125 may also be configured to generate one or more proposed transactions based on a combination of financial parameters and identified vehicles. As detailed above, these proposed transactions may be used to perform searches related to vehicle listings, dealers, and/or the like.

Turning now to FIG. 2, a diagram is provided that describes a data flow 200 related to searching vehicle listings (e.g., searching vehicle listings using the system 100) in accordance with one or more embodiments of the present disclosure. It should be understood that such searches may relate to vehicle purchases, leases, at-risk buying, or any other type of vehicle transaction. To this end, FIG. 2 may be described in conjunction with FIG. 3A, which is a block diagram 300a of various financial parameters included in financial parameters 235, according to one or more embodiments of the present disclosure. However, it should be understood that the financial parameters 235 illustrated in FIG. 3A are merely exemplary, and that various other financial parameters 235 may be contemplated within the present disclosure.

For example, consider a scenario in which a user decides that he/she would like to purchase a vehicle but is unsure of the particular vehicle he/she desires. Instead, the user may first construct financial parameters around which a potential transaction may be built. Thus, the user may, for example, decide on a target price 310 of $36,000 for the vehicle and that he/she would like to provide a down payment 320 of $7,000 towards the purchase of the vehicle. Furthermore, the user may decide he/she is able to obtain a finance rate 350 of 2.9% for a finance length 340 of 60 months. In some implementations, the financing terms 330 may also be based in part on credit data 370, which may be input by the user, provided by third-party service provider servers 107, and/or a combination thereof. The process of determining credit data 370 is described in more detail below with reference to FIG. 3B.

Additionally, the user may decide to trade-in a currently owned vehicle to apply towards the purchase of a potential vehicle. To this end, the user may choose to manually input a trade-in amount to the transaction generation module 230, which may then determine a net-trade-in amount 360. For example, the currently owned vehicle may be worth $6,000, but the user may still owe $2,000 on the old vehicle. Thus, the net trade-in amount 360 would be $4,000. Thus, the financial parameters 235 described above may be received from the user and stored. In certain implementations, the trade-in value of the vehicle may be determined by one or more additional or third party service provider device(s) 107. For instance, the user may input various information associated with a trade-in vehicle, such as its make, model, year, mileage, trim, options, etc. The transaction generation module 230 and/or the financial module 135 may be configured to then provide such information to a third party service provider device 107, which may calculate a net trade-in amount for the trade-in vehicle. In other implementations, such information, in addition to the other financial parameters discussed above, may be incorporated into one or more proposed transactions 210. When a search engine 275 performs a search based on the one or more proposed transactions 210, the search engine 275 may provide the information associated with the trade-in vehicle to the one or more third party service provider devices 107 to calculate a net trade-in amount for the trade-in vehicle. In yet other implementations, the transaction application 125a may guide the user to input the various information associated with the trade-in vehicle in a series of steps.

Continuing with the data flow 200, and as indicated above, the financial parameters 235 may be input into the transaction generation module 230. Once the financial parameters 235 have been input, the transaction generation module 230 may generate one or more proposed transactions 210 based on financial parameters 235. In some embodiments, the one or more generated proposed transactions 210 may be stored on the server 155 in storage 195 and/or on the user device(s) 105. In certain embodiments, the one or more generated proposed transactions 210 may be stored as files. Furthermore, the one or more proposed transactions 210 may be associated with the user, thereby indicating that the proposed transactions 210 are associated with the user.

Additionally, in some embodiments, the one or more proposed transactions 210 may be associated with respective target monthly payments, which may be input by the user or derived from the financial parameters 235. The target monthly payments may represent the monthly payment the user can afford or may expect to pay based on the financial parameters 235. Continuing with the example, the transaction generation module 230 may calculate a target monthly payment of $448 for the potential vehicle purchase.

According to certain embodiments, once the proposed transactions 210 have been generated, the user may wish to search for vehicle listings and/or dealers based on the proposed transactions 210. In some embodiments, these searches may ultimately relate to searching for one or more vehicles to purchase, lease, or otherwise obtain according to certain financial parameters 235. Thus, as shown in FIG. 2, the proposed transactions 210 may be sent to the search engine 275. In some embodiments, the search engine 275 may operate on one or more servers 155 while in other embodiments, the search engine 275 may be executed on a user device 105. Furthermore, the search engine 275 may be configured to return various types of results, depending on the type of search being performed (e.g., as a result of user selection/input). In certain embodiments, the results may relate to finding dealers 220 to negotiate the proposed transactions 210 and/or finding vehicle listings with advertised offers 240 for one or more vehicles. In other embodiments, the search results may also include one or more suggested offers 260 recommended by the search engine 275. In some instances, the suggested offers 260 may be a subset of the advertised offers associated with the returned vehicle listings. In other cases, the suggested offers 260 may be additional promotions or offers that may be relevant to the search. For example, the suggested offers 260 may include offers from dealers outside of a specified geographical area. Additionally, according to some embodiments, the type of search results returned by the search engine 275 may be specified according to user preference. For example, an option to designate the type of search results, such as vehicle purchases, vehicle leases, vehicle listings 240, dealers, and/or the like may be presented to the user through the transaction application(s) 125 and/or through a web page served to the user device(s) 105 by the service provider server(s) 155. Furthermore, one or more of the search results returned by the search engine 175 may be associated with vehicles actually in inventory of one or more of the dealers or sellers. Thus, such search results may present the user with an opportunity purchase, lease, or otherwise obtain a specific vehicle that is actually available as part of a seller's inventory.

Continuing with the above example, one or more vehicle listings (associated with advertised offer(s)) may be returned in response to a search based at least in part on the proposed transaction 210 (e.g., the proposed transaction with a target monthly payment of $448). For instance, a vehicle listing of a BMW vehicle may be returned that is associated with one or more advertised offers from a dealer or a dealership. Such advertised offers may relate to one or more vehicle purchases and/or leases. Furthermore, the one or more advertised offers may be associated with advertised monthly payments that match the target monthly payment of $448 or may approximate the target monthly payment, depending on user preference. For example, the user may specify that the search results return vehicle listings associated with advertised offers that have advertised monthly payments within $30 of the target monthly payment. Under this example, such a range would encompass advertised monthly payments within a range of $418 to $478.

Turning now to FIG. 3B, a data flow 300b for providing and/or generating credit data 370 is illustrated according to one or more embodiments of the present disclosure. As depicted in the data flow 300b, a user 305, one or more third-party service provider devices 107, and/or a combination thereof may provide a credit parameters 380 to the financial module 135. In some embodiments, a user 305 may manually input a credit parameters 380 into the financial module 135. The credit parameters 380 may be a specific number, one or more ranges, and/or a descriptor indicating the credit worthiness of the user 305. For instance, the credit rating may include a precise credit score, such as 700, or it may include a general descriptor such as excellent, good, average, poor, etc.

In some embodiments, one or more third-party service provider devices 107 may be used to provide the credit parameters 380 to the financial module 135. To this end, the user 305 may specify whether the user 305 consents to the transaction application 125 (e.g., the financial module 135) initiating a soft and/or hard credit inquiry to the one or more third-party service provider device(s) 107. For example, the user 305 may grant permission for the financial module 135 to request the user's 305 FICO score, which may be included in the credit parameters 380 provided to the financial module 135.

In other embodiments, the transaction application 125 and/or the financial module 135 may provide an interface for interacting with the user 305 to determine information related the user's 305 credit parameters 380. For example, the financial module 135, through such an interface, may prompt the user for answers to a series of questions related to the user's 305 credit history and/or credit worthiness. Based on the user's 305 answers, the financial module 135 may determine certain credit parameters 380 associated with the user 305.

According to one or more implementations, the financial module 135 may analyze the credit parameters 380 to determine certain credit characteristics associated with the user 305. For instance, the financial module 135 may determine, based at least in part on the credit parameters 380, a credit bucket 390a-n associated with the user 305. As such, the financial module 135 may account for various ranges of credit associated with the user 305. For instance, credit bucket 390a may indicate that a user has relatively good credit while credit bucket 390c may indicate that the user has only fair credit. In other examples, the credit buckets 390A-N may indicate varying credit scores, credit score ranges, other ranges, or any other types of credit indicators. Furthermore, information associated with the credit buckets 390A-N may be included and/or stored in the credit data 370 as part of the financial parameters 235 input into the transaction generation module 130a. Thus, in certain situations, the one or more proposed transactions 210 may include information related to credit buckets 390A-N associate with the user.

In certain embodiments, different credit buckets 390A-N may impact the search results returned by the search engine 175. For example, different advertised offers associated with vehicle listings may be returned to the user 305 by the search engine 175 depending on one or more credit buckets 390A-N associated with the user 305. For instance, the user 305 may be provided advertised offers that include more favorable financing and/or lease terms (e.g., lower interest rate) if the user is associated with a credit bucket 390A-N indicating relatively good credit than if the user is associated with a credit bucket 390A-N indicating relatively poor credit.

FIGS. 4A-4D provide illustrations of one or more user interfaces 400 for searching vehicle listings, according to one or more embodiments of the present disclosure. In some embodiments, the user interface 400 may be provided by the transaction application(s) 125 on the user device(s) 105. In other embodiments, the user interface may be associated with one or more web pages served to the user device(s) 105 by one or more service provider server(s) 155. While not illustrated, some embodiments may enable the user to register with the service provider and/or the transaction application 125. Thus, various information and actions performed by the user or on the user's behalf may be, or the results thereof, may be saved, stored, and/or otherwise associated with the user (e.g., by the service provider servers 155 and/or transaction application 125).

According to one or more embodiments, the user interface 400 may include a transaction generation window 402. In some embodiments, the transaction generation window 402 may be presented to the user as a “wizard” that may guide the user, through a series of steps, in constructing and/or generating one or more proposed transactions. For example, the transaction generation window 402 may prompt the user for information related to financial parameters 235. As shown in FIG. 4A, the “wizard” aspect of the transaction generation window 402 may present the user with an option to enter a target monthly payment 404 or to enter a target price 406 for a potential vehicle purchase.

In some embodiments, the user interface 400 may also include a transaction list window 408 (labeled “My Deals,” for example). The transaction list window 408 may list any transactions (or “deals”) currently associated with the user. In some implementations, in order for the transaction list window 408 to display any transactions, the user may be required to register or sign-up with a particular website and/or application, such as one hosted by the service provider server(s) 155 for example. If the user has not yet registered, as shown in FIG. 4A, a register button 410 may be presented to the user giving the user an option to register or sign up. Alternatively, an identifying cookie or the like may be installed on the user's device. It should be understood that references to buttons on the user interface are merely exemplary, and other types of selection interfaces, such as links, images, forms, and/or the like are also contemplated within the present disclosure.

FIG. 4B shows other aspects of the user interface 400 once the user has proceeded further into the interface 400 provided by the transaction generation window 402. In FIG. 4B, the user has decided on a target price 406 of $36,000. Additionally, the transaction generation window 402 may provide options for the user to enter additional information related to the financial parameters 235. For example, the transaction generation window 402 may give the user the option to enter a trade-in amount 412, a down payment amount 414, or any financing terms 416. With respect to the financing terms 416, as shown in FIG. 4B, the user may have selected financing terms 416 at 2.9% for 36 months. Such financing terms 416 may be offered or may be calculated as obtainable by the user based on, among other things, a credit rating. In some embodiments, the user may input other credit ratings, which may affect the obtainable loan rate and loan length. As described with reference to FIG. 3B above, the credit rating may be provided by the user or by any other third-party service provider 107.

According to certain embodiments, the user may be able to change any of the financial parameters 235 at any time using respective change buttons 418a-d. For instance, the user may select the change button 418b to enter a trade-in amount to be considered for the financial parameters 235. Similarly, the user may select the change button 418c to enter a down payment amount 414. Likewise, the user may edit any of the financial parameters 235 he/she has already entered, such as the target price 406 and/or any part of the financing terms 416 illustrated in FIG. 4B. Such changes may affect certain aspects of any generated proposed transactions, such as the target monthly payment 420.

In some embodiments, the transaction generation window 402 may display the target monthly payment 420, which may be based at least in part on the financial parameters 235 entered by the user. According to the financial parameters 235 entered by the user in FIG. 4B, the target monthly payment 420 may be $559 per month. As previously mentioned, this calculation may be performed by the transaction generation modules 130a-b either on the user device 105 and/or on the service provider server(s) 155. Furthermore, the transaction generation window 402 may display the total cost to finance 422, including taxes, dealer docking fees, prep fees, delivery fees, and/or the like that may be associated with the proposed transaction given the financial parameters 235. As illustrated in FIG. 4B, the total cost to finance 422 may be $38,520.

According to one or more embodiments, the transaction generation window 402 may also include a save button 424 as well as an inventory search button 426 and a dealer search button 428. For instance, the selecting and/or pressing of the save button 424 may initiate the transaction generation modules 130a-b to generate a proposed transaction based on the financial parameters 235 (e.g., the target price 406, net trade-in amount 412, down payment amount 414, and financing terms 416) that the user has entered. In other implementations, the transaction generation modules 130a-b may be configured to generate proposed transactions upon user input of any of the financial parameters. The inventory search button 426 may initiate a search, via the vehicle search module 185 of the search engine 175, for vehicle listings with respectively associated advertised offers. The dealer search button 428 may initiate a search, via the dealer search module 180 of the search engine 175, for dealers that may agree to negotiate on the generated proposed transaction. It should be understood that the same button (.e.g., the save button 424) can be used to activate the transaction generation module 130a-b as well as to save the transaction. Alternatively, separate buttons may be used to save the transaction and to activate the transaction generation module 130a-b.

According to FIG. 4C, the user may have decided to enter further financial parameters 235 for a proposed transaction. For example, the user may have decided to enter a trade-in value 430 for a currently owned vehicle (i.e., in this case, a 1995 Honda Accord EX-L) worth $1,000. However, the user may still have an owed amount 432 of $350 on his Honda Accord. Thus, the net trade-in value 412 of his Honda Accord may be calculated as $650. With a target price 406 of $36,000 and leasing terms 416 of 2.9% for 36 months, the calculated target monthly payment 420 may be determined as $635 per month.

Furthermore, the user may have decided to click on the save button 424, thereby generating a proposed transaction (e.g., a proposed lease) based on the entered financial parameters 235 in the transaction generation window 402. Thus, a summary representation 434 of the proposed transaction associated with a lease may appear in the transaction list window 408. The summary representation 434 may display certain relevant information associated with the proposed transaction. In certain embodiments, the summary representation 434 may display certain financial parameters of the financial parameters 235 associated with the proposed transaction. For example, the summary representation 434 may display the total amount to finance 422, the calculated target monthly payment 420, the financing terms 416, the net trade-in amount 412, and the down payment amount 414.

According to one or more embodiments, if a user clicks the inventory search button 426, advertised offers associated with resulting vehicle listings may also be displayed in the transaction list window 408. Similarly, any offers and/or counteroffers resulting from clicking the dealer search button 428 may also be displayed within the transaction list window 408, or in a pop-up or a separate browser/browser window.

Turning now to FIG. 4D, the user may have decided to change some aspects of the proposed transaction and then to save the changes (e.g., via the save button 424) as a second proposed transaction. To this end, clicking on the save button 424 may present the user with an option to save over the existing proposed transaction, or save the altered financial parameters 235 as a new proposed transaction. In some embodiments, in addition to saving the proposed transaction, selecting the save button 424 may also save and/or store any search results or selected search results (e.g., vehicle listings and/or dealers, etc.) that may have been performed using the proposed transaction. To this end, clicking a summary representations 434, 436 of proposed transactions may enable a user to view saved vehicle associated with searches based on those proposed transactions.

As shown in FIG. 4D, for example, the user may have decided to add a down payment amount 414 of $7,200, which may be based on a 20% down payment. Additionally, the user may have decided to change the proposed transaction to a loan, instead of a lease, with financing terms 416 of 4.25% for 60 months. These changes may result in a calculated target monthly payment 420 of $489 per month and a total amount to finance 422 of $30,121. Additionally, the user may have decided to save the altered financial parameters 235 as a second proposed transaction by clicking the save button 424. Therefore, a second summary representation 436 of the second proposed transaction may be displayed in the transaction list window 408. In some embodiments, the second summary representation 436 may be displayed side-by-side with the first summary representation 434, thereby allowing a relatively quick comparison of respective financial parameters.

According to one or more embodiments, the summary representations 434/436 may also be associated with respective selection buttons 438/440. If a selection button 438/440 is clicked, financial parameters associated with financial parameters 235 for the corresponding proposed transaction may be displayed in the transaction generation window 402, which may provide a more detailed view of the financial parameters 235. Additionally, the user may thereby edit or otherwise change the financial parameters 235 associated with the proposed transaction and save the edits for the proposed transaction and/or save the edits as a new proposed transaction. For example, if the user were to click the selection button 438 associated with the first summary representation 434, the transaction generation window 402 may display information similar to the data displayed by the transaction generation window 402 in FIG. 2C.

According to one or more embodiments, the user interface 400 may also be configured to indicate the degree of progress a user has experienced toward obtaining a new vehicle. Such progress may be saved and associated with the user. For example, depending on which parts of the process the user has completed toward purchasing a vehicle, a progress bar or percentage indicator may be displayed to indicate how close the user is to completing a deal for the vehicle. Alternatively, the interface 400 may display an estimated amount of time the user will need to spend in order to complete a deal. In some implementations, interface 400 may also display the specific tasks that the user has completed as well as any other tasks that have yet to completed. It should be understood that the above examples are merely illustrative, and that any techniques may be used to indicate a user's progress towards purchasing, leasing, or otherwise obtaining a new vehicle.

Thus, the interface 400 (e.g., via the transaction application 125) may also enable the user to drive a selected proposed transaction toward completion (e.g., paying for a selected vehicle) as part of a relatively unified experience. For instance, once the user has selected a vehicle and/or vehicle listing, the user may be able to complete various parts of a deal for the vehicle (e.g., negotiations with one or more dealers, financing terms, lease terms, selected options, payment of the selected vehicle, etc.) through the user interface 400 and/or the transaction application 125. In certain implementations, if a user completes certain aspects of the deal through the user interface 400, the user may be presented with a certificate or any other indicator that may be honored by one or more dealers toward purchasing/leasing a vehicle according to certain terms. Thus, the user may only need to visit a dealership or seller's location to take ownership of the selected vehicle since other aspects of the deal may have been completed beforehand using the interface 400/transaction application 125.

According to one or more embodiments, the user interface 400 and/or transaction application 125 may also provide notifications to a user related to one or more generated proposed transactions. For example, based on any saved or stored proposed transactions, the interface 400/transaction application 125 may notify the user of any new vehicle listings that may match or otherwise correspond to the parameters associated with the proposed transactions.

Thus, the user interface 400 may facilitate generating proposed transactions and storing proposed transactions (e.g., via the transaction generation modules 130a-b). Furthermore, the user interface 400 may facilitate searching for vehicle listings and/or dealers based on the proposed transactions. As such, the user interface 400 may enable users to edit and/or otherwise modify proposed transactions. For example, if the user were to receive a counteroffer from a dealer after conducting a dealer search based on a proposed transaction, the user may use the user interface 400 to select the proposed transaction and make certain adjustments to associated financial parameters. As previously discussed, the user may generate a new proposed transaction from such adjustments, or the user may save the adjustments to the originally proposed transaction. The user may then send the adjusted proposed transaction back to the dealer and/or perform another search based on the adjusted proposed transaction.

According to some embodiments, the user interface 400 may also facilitate providing suggested offers based on the proposed transactions. For example, if an inventory search or a dealer search performed by the search engine 175 yields no results or relatively few results, the search engine 175 may be configured to provide certain suggested offers in response to the search. Such suggested offers may be displayed to the user on the user interface 400, such as in the transaction list window 408. Furthermore, the suggested offers may be based on vehicle listings or dealer offers the search engine 175 may be aware of (e.g., such as inventory that may be stored in storage 195 and/or any other storage).

Turning now to FIG. 5, a flow diagram is illustrated for a method 500 of searching vehicle listings, according to one or more embodiments of the present disclosure. The method 500 may begin in block 510, where transaction generation modules 130a-b may receive one or more financial parameters (e.g., financial parameters 235) input by a user for a vehicle. In some embodiments, the user may input the financial parameters via a transaction application 125 on a user device 105, and the transaction generation module 130a may be included as part of the transaction application 125. Alternatively, the user may input the financial parameters on a web page, via a browser 140. As such, the web page may be served to the web browser 140 on the user device 105 by one or more servers 155. Thus, in certain embodiments, a transaction generation module 130b, executing on the one or more servers 155, may be configured to receive the financial parameters.

Then, in block 520, the transaction generation modules 130a-b may generate one or more proposed transactions, which may be defined, at least in part, by the one or more financial parameters. In some embodiments, the one or more generated proposed transactions may be stored in association with the user. Additionally, the one or more generated proposed transactions may be stored in storage 195 on the service provider server(s) 155. According to some embodiments, the proposed transactions may also be associated with respective target monthly payments that may be calculated from the financial parameters in the financial parameters 235. For example, the transaction generation modules 130a-b may be configured to perform such a calculation. Alternatively, the target monthly payments may simply be input as a financial parameter in financial parameters 235.

In block 530, a search may be performed to determine one or more advertised offers associated with respective vehicles and/or vehicle listings. As such, the determination/search may be based at least in part on the one or more proposed transactions generated by the transaction generation module 130a-b. In some embodiments, a search engine 175 on the service provider server(s) 155 may be configured to receive the one or more proposed transactions and perform a search based on the proposed transactions. In other embodiments, the search may be related to finding dealers that agree to negotiate on the proposed transactions. For example, the search may return contact information of the dealers and/or any counteroffers by the dealers to the proposed transactions. Thus, the search engine 175 may include a dealer search module 180 to find dealers and a vehicle search module 185 to find vehicle listings.

In block 540, the search engine 175 may present at least one advertised offer to a user. In some instances, the advertised offer may match one or more of the proposed deals or may fall within a predetermined range of one or more financial parameters of the proposed deals. For example, the advertised offer may be associated with an advertised monthly payment. As such, the search engine 175 may only return advertised offers that are associated with advertised monthly payments within a predetermined range of the target monthly payment. Alternatively, other financial parameters may be used for comparison, such as the target price 310, financing terms 330, net trade-in amount 360, and/or any other parameters. Furthermore, other types of comparisons may be made, such as determining advertised offers above/below a certain predetermined value.

Thus, according to one or more embodiments, the user may be presented with various options related to specifying certain parameters for the search. For example, such options may include specifying which financial parameters to focus on when searching. To this end, the options may also include specifying any predetermined ranges, or other criteria, that one or more of the financial parameters of the advertised offers must fall within. Additionally, the options may include selecting the type of search (e.g., a dealer search and/or a vehicle listing search) to perform. In some embodiments, these options may be presented to the user by the transaction application 125 on the user device 105. In other embodiments, such options may be presented to the user on a web page served to the user by the service provider server(s) 155.

It should be noted that the present disclosure is not limited to generating proposed transactions, and searching for vehicle listings and/or dealers based in part on the proposed transactions, with respect to only new vehicle purchases or leases. For example, the system 100 may also be configured to generate proposed transactions and perform searches related to used vehicles as well.

FIG. 6 shows a block diagram 600 of a dealer device 605 in accordance with one or more embodiments of the present disclosure. In some embodiments, the dealer device 605 may be in communication with the user device 105 and the server 155 via the network(s) 150. The dealer device 605 may include one or more processors 610, a memory 615, and a display 640. Furthermore, the memory 615 may include a dealer application 620 and a browser 635. The dealer application 620 may include a transaction-offer module 625 and an inventory module 630.

According to one or more embodiments, the dealer application 620 in the dealer device(s) 605 may be configured to receive and/or analyze user-generated proposed transactions and dealer preferences to facilitate the construction of counteroffers to proposed transactions. Such proposed transactions may be generated by the transaction generation modules 130a-b in the user device(s) 105 and/or the servers 155. For example, when a user performs a search based on generated proposed transactions, the dealer application 620 may be configured to receive (e.g., from the dealer search module 180) and analyze the proposed transactions to construct one or more counteroffers.

In some embodiments, the transaction-offer module 625 may be configured to monitor proposed transactions used in searches for vehicle listings and/or dealers. For instance, when proposed transactions are sent to the search engine 175, the transaction-offer module 625 may be configured to identify those proposed transactions. Alternatively, once the search engine 175 receives the proposed transactions by the transaction generation modules 130a-b, the search engine 175 may be configured to send the proposed transactions to the transaction-offer module 625 of the dealer application 620 in the dealer device 605.

According to certain embodiments, the transaction-offer module 625 may analyze the proposed transactions, such as associated financial parameters 235, to decide one or more terms of a potential counteroffer. As such, the transaction-offer module 625 may adjust one or more of the financial parameters in the financial parameters 235 and construct/generate a counteroffer based on the adjustments. To this end, any generated counteroffers may be sent by the dealer application 620 to the search engine 175, which may return the generated counteroffers to the user as search results.

In some embodiments, the transaction-offer module 625 may generate counteroffers based on certain profit margins the dealer may wish to retain. For example, the dealer may wish to protect profit margin with respect to the target price 310, financing terms 330, net trade-in amount 360, and/or any other financial parameter(s). To this end, the dealer application 620 may provide one or more options, such as in a user interface, for the dealer to select with respect to the types of profit margins the dealer wishes to protect. In other embodiments, the dealer may remain indifferent as to where the dealer retains profit. Therefore, the dealer application 620 may enable the dealer to input a particular profit amount or profit percentage to retain per transaction with respect to any generated counteroffers.

According to one or more embodiments, the dealer application(s) 620 may also include an inventory module 630 to track or monitor vehicle inventory associated with the dealer. As such, the inventory module 630 may maintain pricing information and other financial parameters for respective vehicles in the dealer's inventory. In some embodiments, the inventory module 630 may communicate with the transaction-offer module 625 to identify inventory-specific opportunities. As such, the inventory module 630 may analyze one or more proposed transactions received/retrieved by the transaction-offer module 625 to identify relatively aged inventory that may be suitable for the proposed transaction.

For example, a user may conduct a search using a proposed transaction with a target price of $30,000. This proposed transaction may be received/retrieved by the transaction-offer module 625 in the dealer application 620. Additionally, the inventory module 630 may identify or determine that a previous year model of a Ford Mustang has been in inventory for too long. To this end, the inventory module 630 may analyze the proposed transaction and determine that based on the $30,000 target price, the dealer should accept the proposed transaction for the Ford Mustang and/or generate a counteroffer associated with the Ford Mustang. It should be understood that the dealer application 620 may provide various other metrics (e.g., supply and demand metrics) to facilitate determination of whether the dealer should accept a particular proposed transaction and/or construct a counteroffer. For example, such metrics may include, but are not limited to, market day supply, number of vehicles in market, time to sale, market pricing and price trends, end of model year/timing, amount paid for trade-in, reconditioning and other costs associated with the vehicle, impending model year redesigns, wholesale market, and/or the like.

In addition, according to other embodiments, the dealer application 620 may reside in the service provider server(s) 155. As such, the dealer device(s) 605 may communicate with the dealer application 620 via the browser 635. In certain embodiments, the dealer application 620 and/or other components in the service provider server(s) 155 may serve a web page or a web interface to the dealer device 605. Thus, the dealer application 620, and its included transaction-offer module 625 and inventory module 630, may execute on the service provider server(s) 155 rather than on the dealer device(s) 605.

Furthermore, the interactions of the dealer application 620 with the service provider servers 155, user device 105, and/or any other component in communication with the network 150 may be performed with varying degrees of dealer input. For instance, generating counter-offers to proposed transaction and/or identifying inventory-specific opportunities may be performed automatically by the dealer application 620 according to certain parameters set by a user. Alternatively, the user may desire the dealer application 620 to notify the user of certain proposed transactions, and the user may manually input certain aspects of a proposed counter-offer.

Certain embodiments of the present disclosure are described above with reference to block and flow diagrams of systems and methods and/or computer program products according to example embodiments of the present disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the present disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments of the present disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of the present disclosure have been described in connection with what is presently considered to be the most practical and various embodiments, it is to be understood that the present disclosure is not to be limited to the disclosed embodiments, but is intended to cover various modifications and equivalent arrangements included within the scope of the appended claims. Although specific terms are employed herein, they are used in a generic and descriptive sense only and not for purposes of limitation.

This written description uses examples to disclose certain embodiments of the present disclosure, including the best mode, and also to enable any person skilled in the art to practice certain embodiments of the present disclosure, including making and using any devices or systems and performing any incorporated methods. The patentable scope of certain embodiments of the present disclosure is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method, comprising:
receiving, by a computer comprising one or more processors, one or more financial parameters;
generating, by the computer, one or more proposed transactions, the one or more proposed transactions defined at least in part by the one or more financial parameters;
determining, by the computer based at least in part on the one or more proposed transactions, one or more advertised offers associated with respective vehicles; and
transmitting, by the computer, the one or more advertised offers.

2. The method of claim 1, further comprising determining, by the computer, at least one dealer associated with at least one of the one or more advertised offers.

3. The method of claim 2, further comprising transmitting, by the computer, the one or more proposed transactions to the at least one dealer.

4. The method of claim 3, further comprising determining, by the computer based at least in part on the one or more proposed transactions, one or more proposed counteroffers, from one or more respective dealers, to the one or more proposed transactions.

5. The method of claim 1, wherein the one or more proposed transactions are associated with respective target monthly payments, and the at least one advertised offer is associated with respective advertised monthly payments.

6. The method of claim 5, wherein the respective advertised monthly payments are within a predetermined range of the respective target monthly payments.

7. The method of claim 1, further comprising storing the one or more proposed transactions, in association with the user, in the computer.

8. The method of claim 7, further comprising storing the one or more advertised offers, in association with the user, in the computer.

9. The method of claim 8, further comprising optionally selecting, by the computer based on user input, at least one of the one or more proposed transactions and at least one of the one or more advertised offers to display side-by-side.

10. The method of claim 1, wherein the one or more financial parameters include at least one of a down payment parameter, a finance length parameter, a finance rate parameter, a trade-in value parameter, a leasing term parameter, or a leasing rate parameter.

11. A device, comprising:
at least one processor;
at least one memory storing computer-readable instructions, that when executed by the at least one processor, cause the at least one processor to:
receive one or more financial parameters associated;
generate one or more proposed transactions based at least in part on the one or more financial parameters;
determine, based at least in part on the one or more proposed transactions, one or more advertisements for respective vehicles, the one or more advertisements associated with one or more advertised financial parameters within a predetermined range of at least one of the one or more financial parameters.

12. The device of claim 11, wherein the instructions further cause the at least one processor to determine, based at least in part on the one or more proposed transactions, at least one dealer associated with at least one of the one or more advertisements.

13. The device of claim 12, wherein the instructions further cause the at least one processor to transmit the one or more proposed transactions to the at least one dealer.

14. The device of claim 13, wherein the instructions further cause the at least one processor to determine one or more proposed counteroffers, from one or more respective dealers, to the one or more proposed transactions.

15. The device of claim 11, wherein the one or more proposed transactions are associated with respective target monthly payments, and the one or more advertisements are associated with respective advertised monthly payments.

16. The device of claim 15, wherein the respective advertised monthly payments are within a predetermined range of the respective target monthly payments.

17. The device of claim 11, wherein the instructions further cause the at least one processor to display at least one of the one or more advertisements and at least one of the one or more proposed transactions side-by-side.

18. The device of claim 11, wherein the one or more financial parameters include at least one of a down payment parameter, a finance length parameter, a finance rate parameter, a trade-in value parameter, a leasing term parameter, or a leasing rate parameter.

19. A non-transitory computer-readable medium storing instructions that when executed by one or more processors, cause the one or more processors to:
receive one or more financial parameters;
generate one or more proposed transactions, the one or more proposed transactions defined by the one or more financial parameters;
determine, using the one or more proposed transactions, one or more advertisements associated with respective vehicles; and
transmit the one or more advertisements.

20. The non-transitory computer-readable medium of claim 19, further comprising instructions that cause the one or more processors to:
determine, using the one or more proposed transactions, one or more dealers associated with the at least one of the one or more advertisements; and
transmit the one or more proposed transactions to the one or more dealers.
